(19) United States
(12) Patent Application Publication
(10) Pub. No.: US 2024/0256839 A1
(43) Pub. Date: Aug. 1, 2024

(54) METHODS, SYSTEMS, ARTICLES OF MANUFACTURE AND APPARATUS TO GENERATE FLOW AND AUDIO MULTI-MODAL OUTPUT

(71) Applicant: Intel Corporation, Santa Clara, CA (US)

(72) Inventors: Jiaxiang Jiang, Santa Clara, CA (US); Mahesh Subedar, Portland, OR (US)

(21) Appl. No.: 18/635,844

(22) Filed: Apr. 15, 2024

(51) Int. Cl. G06N 3/047; G06N 3/0464

(52) U.S. Cl. CPC G06N 3/047; G06N 3/0464

(57) ABSTRACT

Methods, systems, articles of manufacture, apparatus and methods are disclosed to generate flow and audio multi-modal output. An example apparatus includes interface circuitry, machine-readable instructions, and at least one processor circuit programmed by the machine-readable instructions to train an unsupervised image model to generate flow tensors based on a reference frame and a driver frame, the flow tensors representing at least one of rotation information or translation information. The example apparatus also includes at least one processor circuit programmed by the machine-readable instructions to train a denoising diffusion probabilistic model (DDPM) based on (a) the flow tensors, (b) audio distributions and (c) prompt signals, the trained DDPM to temporally align the flow tensors with the audio distributions.

### BACKGROUND

Volumetric video content is generated with arrays of cameras positioned in a particular orientation around one or more objects. Public attraction to volumetric video content consumption has resulted in a market expected to reach over eleven billion dollars by the year 2030.

### BRIEF DESCRIPTION OF THE DRAWINGS

FIG. 1 is a block diagram of an example environment in which example multi-modality circuitry operates to generate flow and audio multi-modal output.

FIG. 2 is a block diagram of an example implementation of the multi-modality circuitry of FIG. 1.

FIG. 3 is a block diagram of a latent flow prediction model instantiated by the multi-modality circuitry of FIG. 1 to generate flow information.

FIG. 4 is a block diagram of a flow/audio denoising diffusion probabilistic model (DDPM) instantiated by the multi-modality circuitry of FIG. 1 to align flow information with audio information.

FIG. 5 is a block diagram of a latent flow diffusion model (LFDM) instantiated by the multi-modality circuitry of FIG. 1 to generate time-synchronized audio with video.

FIGS. 6-7 are flowcharts representative of example machine readable instructions and/or example operations that may be executed, instantiated, and/or performed by example programmable circuitry to implement the multi-modality circuitry 108 of FIGS. 1 and 2.

FIG. 8 is a block diagram of an example processing platform including programmable circuitry structured to execute, instantiate, and/or perform the example machine readable instructions and/or perform the example operations of FIGS. 6-7 to implement the multi-modality circuitry 108 of FIGS. 1 and 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Volumetric video permits viewers to explore three-dimensional (3D) content at different angles of a scene during video playback. Users consuming volumetric video participate in an immersive capability that includes use cases related to healthcare, sports and education. Creating such volumetric video content involves a substantial hardware investment for numerous cameras that are synchronized to capture different angles of the scene. Specialized hardware includes high-resolution cameras, depth sensors (e.g., LiDAR sensors) and motion capture systems. Typically, film professionals are needed to edit and stitch the multi angle images together in a manner that results in a 3D video. In some circumstances the film professionals incur additional expenses for dedicated software to assist with 3D reconstruction, compression and data optimization of captured scene information.

Examples disclosed herein reduce high cost barriers to enter the field of volumetric video creation, and enable the generation of sequences of video with audio based on two-dimensional (2D) image inputs acquired by any type of image capture device. Examples disclosed herein apply 2D image inputs to a particular machine learning framework to generate flow information indicative of different viewpoints of an object. Such generated flow information includes vector representations of image translation, rotation, and is warped by examples disclosed herein to generate and/or otherwise derive alternate image views that are guided and/or otherwise prompted by text and/or vocal prompt inputs (e.g., rotate around object clockwise, rotate around object counter clockwise, etc.). Stated differently, examples disclosed herein perform warp operations (e.g., geometric transformations) on latent space information (rather than relatively bandwidth-demanding image space information) to generate subsequent image views that are guided and/or otherwise based on flow tensors derived from prompt information (e.g., rotate left, rotate right, etc.).

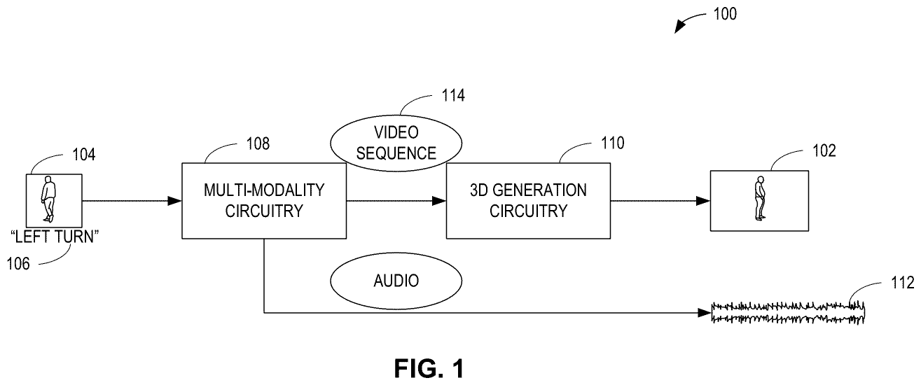

FIG. 1 is an example generative artificial intelligence (AI) pipeline 100 (e.g., sometimes referred to herein as a multi-modality environment, or a generative AI framework) to generate volumetric video 102 and audio 112 based on a set of multi-view 2D images 104 and a prompt 106 (e.g., a text description corresponding to viewing instructions). In the illustrated example of FIG. 1, the pipeline 100 includes multi-modality circuitry 108 communicatively connected to 3D generation circuitry 110. In operation, the example pipeline 100 operates in a training mode or an inference mode, both of which are described in further detail below. In the inference mode, the pipeline 100 receives and/or otherwise retrieves image input 104 (e.g., one or more frames of video) and an associated prompt 106, both of which are processed by the example multi-modality circuitry 108 to generate an audio/flow pair (multi-modality) as a video sequence 114 and the audio 112. The example 3D generation circuitry 110 generates 3D volumetric video 102 time sequenced with the audio 112. In the training mode, the example multi-modality circuitry 108 instantiates an unsupervised learning process to train a latent flow prediction model for pairs of video frames. In particular, the unsupervised learning process derives and/or otherwise generates flow tensors based on pair-wise comparisons of the video frames, which are initially in a relatively high-bandwidth format/representation, and initially pay no regard to coherency and/or ordering of such flow tensors. However, during training tasks the latent flow prediction model contributes to the training of a flow/audio denoising diffusion probabilistic model (DDPM) reverse process to generate coherency and/or ordering of the flow tensors based on prompt information. Additionally, a separate training stage includes a conditional learning stage of the DDPM based on audio information and one or more prompts of interest (e.g., “dance and rotate”). The conditional learning stage trains the DDPM with a forward process that adds noise to audio and flow at iterative diffusion operations, and an example reverse (e.g., denoise) process utilizes a coupled UNet diffusion model (ϕ) to learn to reconstruct the audio and flow from noise that is conditioned on the prompt(s).

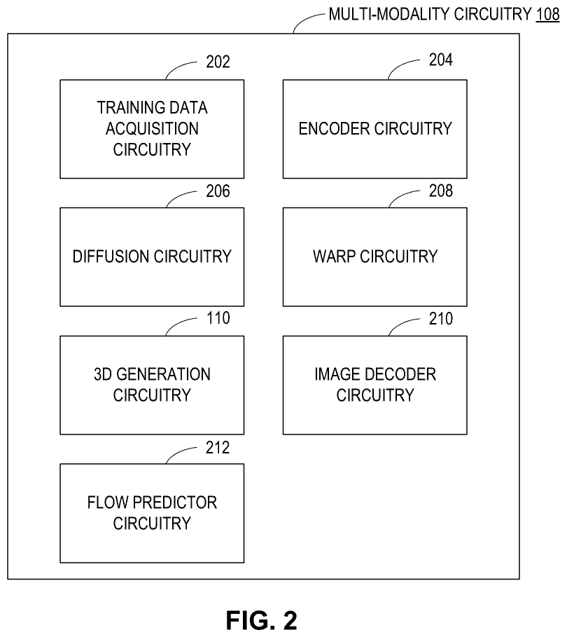

FIG. 2 is a block diagram of an example implementation of the mutli-modality circuitry 108 of FIG. 1 to do flow and audio multi-modal output generation. The multi-modality circuitry 108 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the multi-modality circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example multi-modality circuitry 108 of FIG. 2 includes example training data acquisition circuitry 202, example encoder circuitry 204, example diffusion circuitry 206, example warp circuitry 208, example image decoder circuitry 210, example flow predictor circuitry 212, and the example 3D generation circuitry 110. In some examples, one or more elements of FIG. 2 may be part of a similar on-chip system or system-on-chip (SoC) assembly, and in some examples one or more elements of FIG. 2 may 2 may be on separately located circuits and/or systems. In some examples training tasks and inference tasks are performed by the same circuitry or computational hardware, while in some examples training tasks are performed on first computational hardware while inference tasks are performed on second computational hardware.

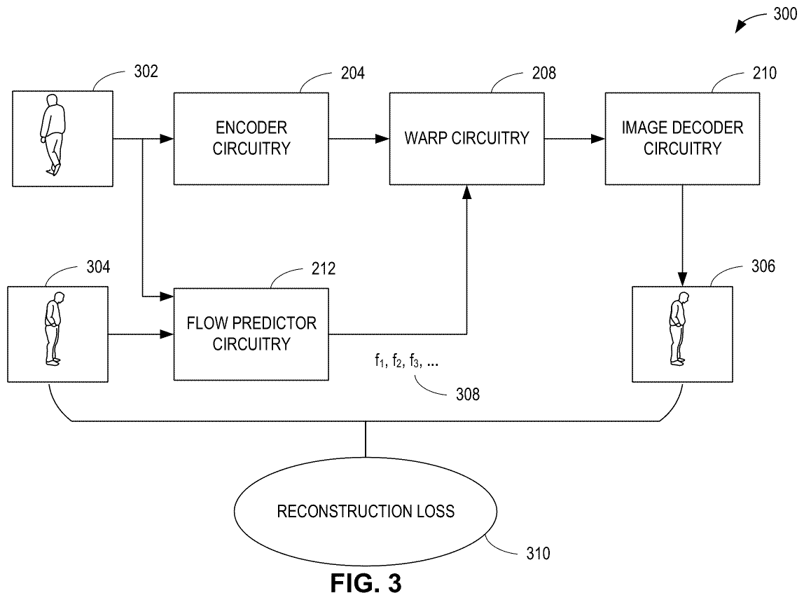

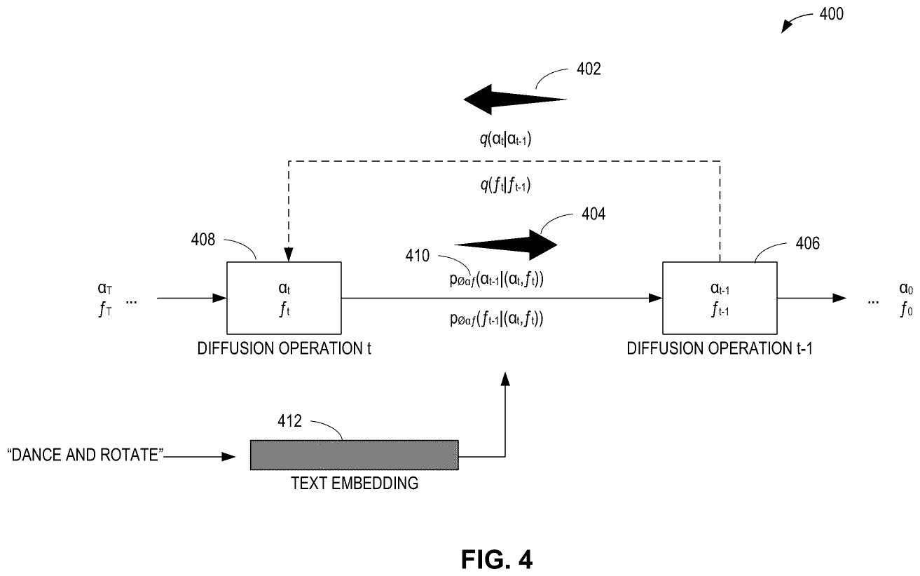

In operation, and during an initial training phase, the example training data acquisition circuitry 202 performs two training phases. A first training phase includes unsupervised learning of a latent flow prediction model for pairs of video frames to generate flow information (e.g., flow tensors), which is described below in connection with FIG. 3. A second training phase includes conditional learning to train a diffusion model for flow and audio generation in connection with prompt information, which also results in temporal alignment of the flow information and audio information and is described below in connection with FIG. 4.

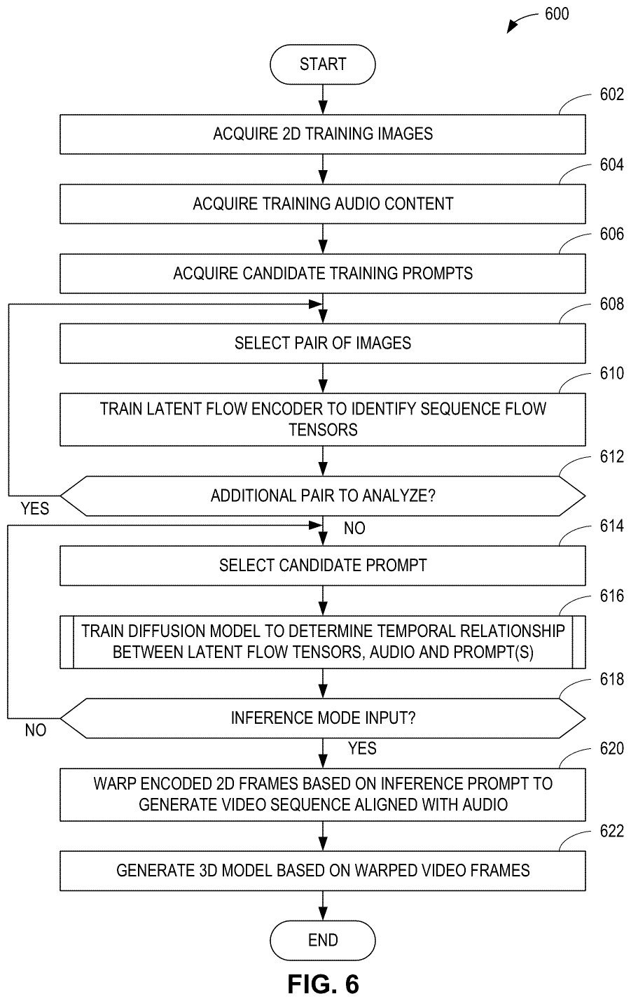

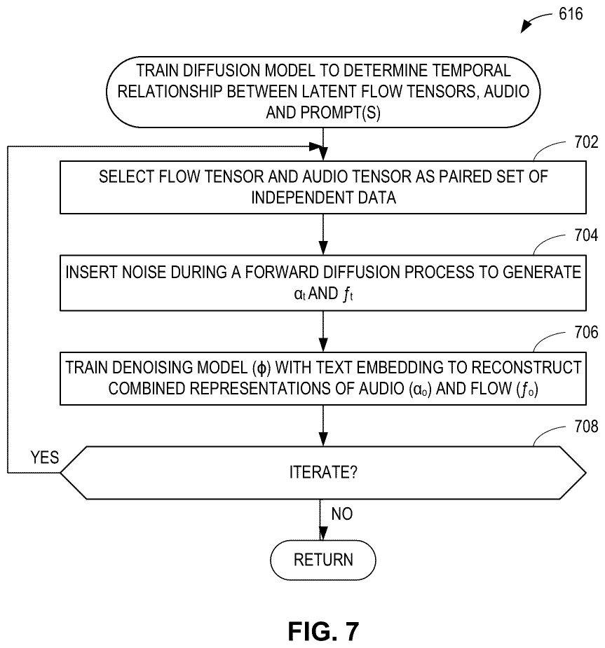

In some examples, the training data acquisition circuitry 202 is instantiated by programmable circuitry executing training data acquisition instructions and/or configured to perform operations such as those represented by the flowchart(s) of FIGS. 6 and 7. In some examples, the encoder circuitry 204 is instantiated by programmable circuitry executing encoding instructions and/or configured to perform operations such as those represented by the flowchart(s) of FIGS. 6 and 7. In some examples, the diffusion circuitry 206 is instantiated by programmable circuitry executing diffusion instructions and/or configured to perform operations such as those represented by the flowchart(s) of FIGS. 6 and 7. In some examples, the warp circuitry 208 is instantiated by programmable circuitry executing warp instructions and/or configured to perform operations such as those represented by the flowchart(s) of FIGS. 6 and 7. In some examples, the 3D generation circuitry 110 is instantiated by programmable circuitry executing 3D video generation instructions and/or configured to perform operations such as those represented by the flowchart(s) of FIGS. 6 and 7. In some examples, the image decoder circuitry 210 is instantiated by programmable circuitry executing image decoding instructions and/or configured to perform operations such as those represented by the flowchart(s) of FIGS. 6 and 7. In some examples, the flow predictor circuitry 212 is instantiated by programmable circuitry executing flow prediction instructions and/or configured to perform operations such as those represented by the flowchart(s) of FIGS. 6 and 7.

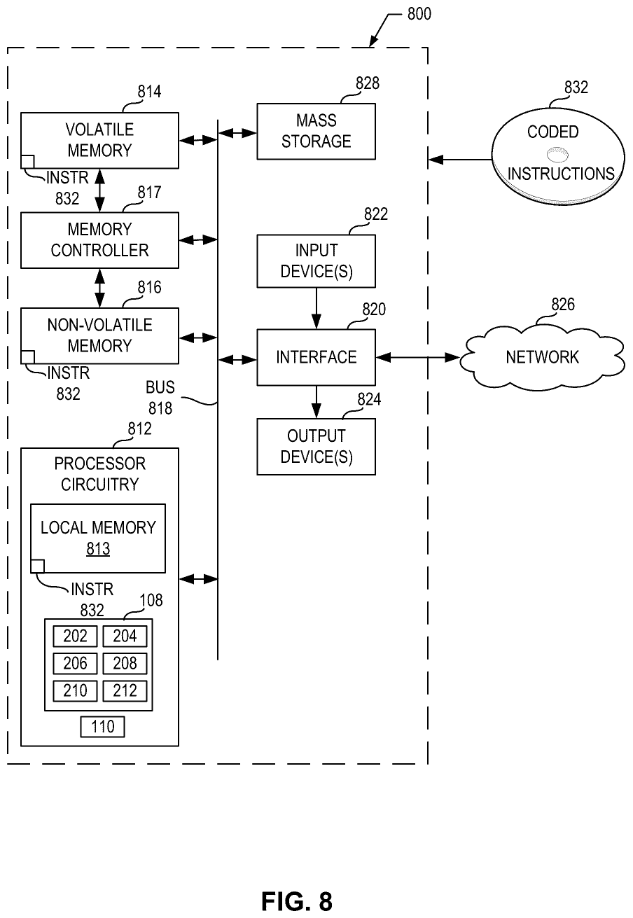

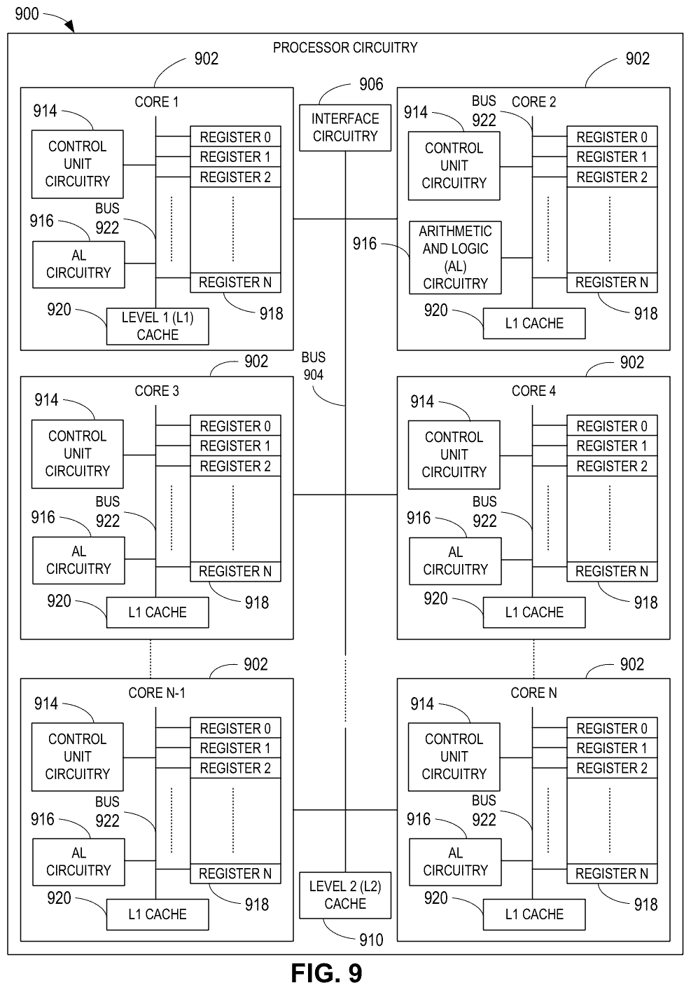

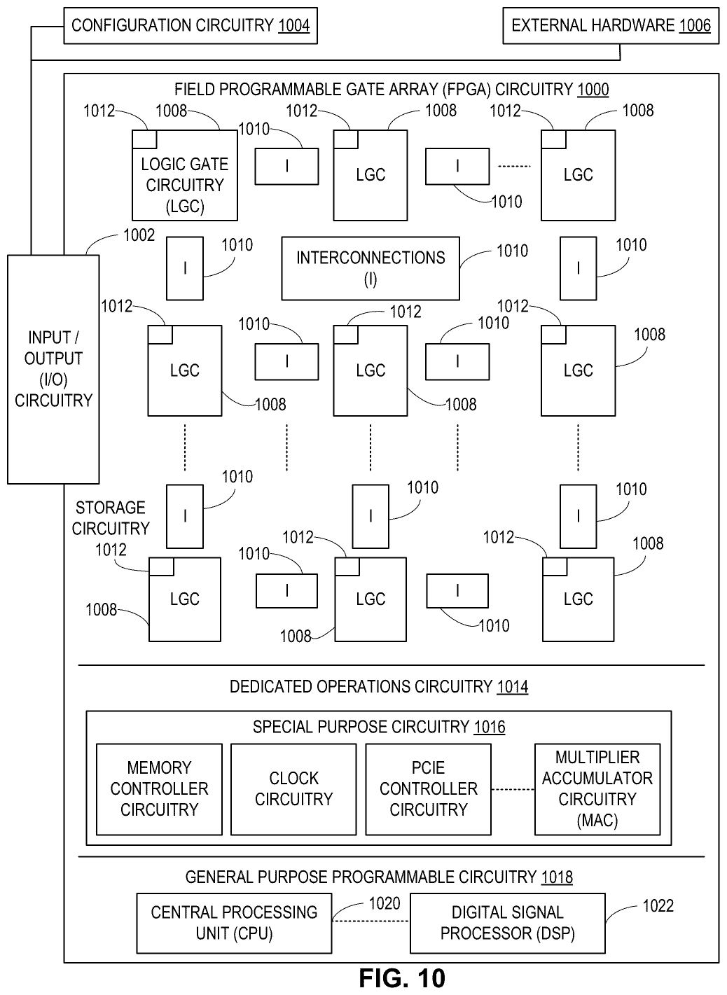

In some examples, the multi-modality circuitry 108 includes means for acquiring training data. For example, the means for acquiring may be implemented by training data acquisition circuitry 202. In some examples, the multi-modality circuitry 108 includes means for encoding. For example, the means for encoding may be implemented by encoder circuitry 204. In some examples, the multi-modality circuitry 108 includes means for diffusing. For example, the means for diffusing may be implemented by diffusion circuitry 206. In some examples, the multi-modality circuitry 108 includes means for warping. For example, the means for warping may be implemented by warp circuitry 208. In some examples, the multi-modality circuitry 108 includes means for 3D generation. For example, the means for 3D generation may be implemented by 3D generation circuitry 110. In some examples, the multi-modality circuitry 108 includes means for image decoding. For example, the means for image decoding may be implemented by image decoder circuitry 210. In some examples, the multi-modality circuitry 108 includes means for predicting flow. For example, the means for predicting flow may be implemented by flow predictor circuitry 212. In some examples, the training data acquisition circuitry 202, the encoder circuitry 204, the diffusion circuitry 206, the warp circuitry 208, the 3D generation circuitry 110, the image decoder circuitry 210 and/or the flow predictor circuitry 212 may be instantiated by programmable circuitry such as the example programmable circuitry 812 of FIG. 8. For instance, the aforementioned circuitry may be instantiated by the example microprocessor 900 of FIG. 9 executing machine executable instructions such as those implemented by at least blocks of FIGS. 6 and 7. In some examples, the aforementioned circuitry may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a latent flow prediction model 300 (sometimes referred to herein as an unsupervised image model) to generate flow information. The example unsupervised learning framework 300 of FIG. 3 includes the encoder circuitry 204, the warp circuitry 208, the image decoder circuitry 210, and the flow predictor circuitry 212. The example training data acquisition circuitry 202 acquires a reference image 302 (e.g., a reference frame) and a driving image 304 (e.g., a driving frame). Generally speaking, the reference image 302 represents a starting point of an image and the driving image 304 represents a destination image and/or otherwise a final image representation to be determined. At least one objective of the first training phase of the unsupervised learning framework 300 is to reconstruct the example driving image 304 as a matching output image 306. Stated differently, when starting from the reference image 302 there are particular translations and/or rotations (e.g., flow) that occur to result in an end-game and/or otherwise final representation of the driving image 304. The example latent flow prediction model 300 learns and/or otherwise generates flow tensor information that, when applied to the reference image 302, will result in a matching output image 306 that mirrors the driving image 304.

In operation, the encoder circuitry 204 transforms and/or otherwise encodes the reference image 302 from an image space (e.g., high density) to a vector representation having a relatively lower sized latent space to permit improved computational efficiency. In some examples, the reference image 302 and the driving image 304 are randomly selected from a same video and have the same dimensions (e.g., RGB frames of size H×W×3). The example reference image 302 is also fed into the example flow predictor circuitry 212 to perform a differentiable bilinear sampling operation and estimate occlusions (e.g., a latent occlusion map having values from 0 to 1 to indicate a degree of occlusion relative to and/or otherwise between the reference image 302 and the driving image 304). The example warp circuitry 208 performs warping operations via element-wise multiplication that are fed to the example image decoder circuitry 210. Flow information generated by the example flow predictor circuitry 212 is updated on an iterative basis with a feedback loop that calculates a reconstruction loss between respective output images 306 and the driving image 304 (e.g., the “ground truth” image). In some examples, the warp circuitry 208 warps flow tensors generated by the flow predictor circuitry 212 based on a difference relative to (e.g., between) a first representation of the reference image 302 and the driving image 304. The example unsupervised learning framework 300 generates flow information as flow tensors 308 (e.g., f₁, f₂, f₃, etc.). Iterations of the unsupervised learning framework 300 calculate a reconstruction loss 310 to signal and/or otherwise trigger an end to training for pairwise selected images. In some examples, a threshold value of diminishing error from one iteration to a next iteration determines when to end training that generates the flow tensors 308.

FIG. 4 is an example flow/audio denoising diffusion probabilistic model (DDPM) 400 to align flow information with audio information in connection with prompt information. In the illustrated example of FIG. 4, the DDPM 400 includes a forward diffusion process 402 to add noise to audio samples (a₀) (e.g., noise infused audio) and flow samples (f₀) (e.g., noise infused flow tensors) (e.g., flow tensors 308 described above in connection with FIG. 3). As a result, the forward process 402 generates noise infused flow tensors and audio distributions. The illustrated example of FIG. 4 also includes a reverse diffusion process 404, which is sometimes referred to as a denoising process to reconstruct the flow and audio information from the noise infused flow tensors and audio distributions. The reverse diffusion process 404 models a joint distribution of the flow (f) and audio (a) in which a joint distribution model (ϕ) predicts flow and audio information (e.g., multi-modal) extracted from the noise. Audio information includes a large number of samples and data sources that include music, narration and/or sound effects. Generally speaking, the example DDPM 400 transfers two separate distributions of flow and audio into unstructured noise, such as Gaussian noise, to learn how to recover (reconstruct) data therein. In some examples, recovery of flow and associated audio includes training the joint distribution model (ϕ), such as a fully convolutional neural network (e.g., a unified coupled UNet model).

The example diffusion circuitry 206 selects a flow tensor (fₜ₋₁) and an audio tensor (aₜ₋₁) at a first diffusion process 406, which is a paired set of independent data. The diffusion circuitry 206 injects noise during the forward diffusion process 402 to generate a corresponding noise audio tensor (aₜ) and noise flow tensor (fₜ) at a second (e.g., subsequent) diffusion process 408. The diffusion circuitry 206 trains the joint distribution model (ϕ) 410 based on a text embedding of interest 412 to reconstruct the combined representations of the audio tensor (aₜ) and the noise flow tensor (fₜ) in an effort to match original versions thereof. The example DDPM 400 iterates in a manner in which noise added to the audio and flow information eventually transforms such information into only a noise signal (e.g., the forward diffusion process 402). The reconstruction during the reverse diffusion process 404 trains the joint distribution model 410 such that each model iteration improves the ability to derive meaningful and related flow and audio information based on the input prompt. As such, during later inference operations of the DDPM 400 start with noisy inputs that can be temporally synchronized audio with video (based on the trained flow).

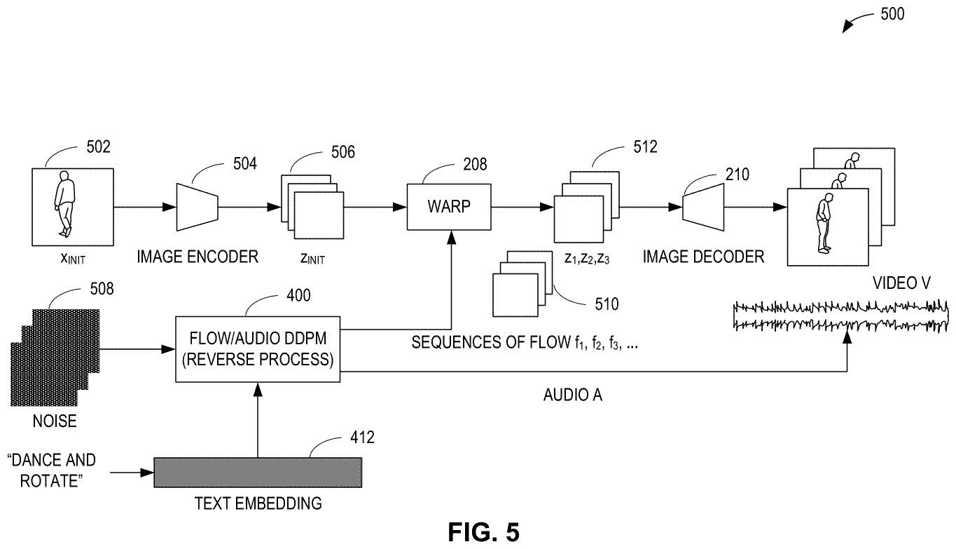

FIG. 5 is an example latent flow diffusion model (LFDM) 500 to generate time-synchronized video and audio based on an input image frame and a prompt. In the illustrated example of FIG. 5, the LFDM 500 includes an input image 502, an image encoder 504 to generate a latent space representation 506 of the input image 502, and the warp circuitry 208. The example LFDM 500 of FIG. 5 also includes the flow/audio DDPM 400 having a noise input 508 (e.g., Gaussian noise) and the text embedding of interest 412 (e.g., a prompt), such as a desired action or modification that is to be applied to the input image 502 (e.g., “dance and rotate”). In the illustrated example of FIG. 5, the flow/audio DDPM 400 operates in a reverse process (a model inference mode) to generate sequences of flow information 510 (e.g., flow vectors/tensors f₁, f₂, f₃, etc.) that are provided to the example warp circuitry 208, which generates warped and/or otherwise modified representations of the flow information 512. The LFDM 500 of FIG. 5 includes image decoder circuitry 210 to transform the warped flow information 512 from the latent space back to an image space for rendering video.

In operation, at least one objective of the LFDM 500 is to arrange flow information based on the text embedding of interest 412 (prompt) so that such flow information is placed in an order that is consistent with the prompt, audio and the input image 502. Because the input image 502 is a frame from a video of interest, it resides in an image space. To improve computational efficiency, the image encoder 504 transforms the frame in the image space to a relatively less bandwidth intensive latent space representation 506. Based on the prompt 412, the previously trained flow/audio DDPM 400 operates in a reverse process to generate the flow information 510, which is fed to and/or otherwise transmitted to the warp circuitry 208. The warp circuitry 208 uses the flow information as input to determine how much to change the input image 502. In some examples, the warp circuitry 208 executes a geometric transformation of a first view to a subsequent (e.g., warped/modified) view in the latent space. The result of the warping operation(s) is warped flow information 512 (e.g., warped flow tensors z₁, z₂, z₃, etc.) that is temporally coherent with audio. In some examples, the 3D generation circuitry 110 generates multi-view images based on the warped flow information 512 with an image translation algorithm and a DNN model to map 2D images to a 3D volumetric field.

While an example manner of implementing the multi-modality circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example training data acquisition circuitry 202, the example encoder circuitry 204, the example diffusion circuitry 206, the example warp circuitry 208, the example 3D generation circuitry 110, the example image decoder circuitry 210, the example flow predictor circuitry 212, and/or, more generally, the example multi-modality circuitry 108 of FIG. 2, may be implemented by hardware alone or by hardware in combination with software and/or firmware. Thus, for example, any of the example training data acquisition circuitry 202, the example encoder circuitry 204, the example diffusion circuitry 206, the example warp circuitry 208, the example 3D generation circuitry 110, the example image decoder circuitry 210, the example flow predictor circuitry 212, and/or, more generally, the example multi-modality circuitry 108 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example multi-modality circuitry 108 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the multi-modality circuitry 108 of FIG. 2 and/or representative of example operations which may be performed by programmable circuitry to implement and/or instantiate the multi-modality circuitry 108 of FIG. 2, are shown in FIGS. 6-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-7, many other methods of implementing the example multi-modality circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to generate flow and audio multi-modal output. The example machine-readable instructions and/or the example operations 600 of FIG. 6 begin at block 602, at which the training data acquisition circuitry 202 acquires two-dimensional (2D) training images, such as labeled images and/or image frames from video. The example training data acquisition circuitry 202 also acquires training audio content (block 604), which may include millions of audio tracks, such as music, sound effects, instructional dialog, etc. The example training data acquisition circuitry 202 also acquires candidate training prompts (block 606), such as text prompts indicative of image control and/or text prompts that identify desired changes to be made to an input image (e.g., text prompts indicative of a desire to make the image dance and rotate).

As described above, flow information identifies different types and/or magnitudes of rotation and translation that cause an image to change from a first representation to a second (e.g., subsequent or prior) representation. However, because image data is bandwidth intensive, the example encoder circuitry 204 selects pairs of images (block 608) and translates them into a latent space. The encoder circuitry 204 trains the latent flow prediction model 300 to generate sequence flow tensors based on the selected pairs of images (block 610). In the event additional pairs of images are available for analysis (block 612), control returns to block 608 where the encoder circuitry 204 selects another pair of images.

After flow information has been generated for any number of pairs of images, examples disclosed herein associate the flow information with prompt information and audio information so that video and audio data can be temporally aligned. The example diffusion circuitry selects a candidate prompt (block 614) and trains the diffusion model (e.g., the flow/audio DDPM 400 of FIG. 4) to determine a temporal relationship between the latent flow tensors, the audio and the selected prompt (block 616), as described above and in further detail below. The example multi-modality circuitry 108 determines if the diffusion model is still in a training mode or an inference mode (block 618). In particular, the example diffusion model includes both a reverse process (for inference operation) and a forward process (for training). If the example multi-modality circuitry 108 determines that training mode is to continue (e.g., one or more additional prompts are to be considered when training), then control returns to block 614 where the diffusion circuitry selects another candidate prompt for consideration.

FIG. 7 is a flowchart illustrating additional detail for the diffusion circuitry 206 efforts to train the diffusion model of block 616. In the illustrated example of FIG. 7, the diffusion circuitry 206 selects a flow tensor and an audio tensor as a paired set of independent data (block 702). The diffusion circuitry 206 injects noise during a forward diffusion process (pass) to generate representative flow tensors and audio tensors having noise added thereto (block 704) and then trains a denoising model with a prompt of interest to reconstruct the combined representations of audio and flow information (block 706). The diffusion circuitry 206 iterates the forward and reverse process based on any type of iteration termination trigger (block 708), such as a number of iterations, a threshold value of diminishing error per iteration, etc. Control then returns to block 618 of FIG. 6.

The example warp circuitry 208 is invoked during an inference mode of the diffusion model, in which the diffusion model operates with a reverse process to extract flow information from an image input and a prompt (block 620). Based on the video sequence tensors generated by the warp circuitry 208, the 3D generation circuitry 110 applies a 3D model to generate video frames aligned with the audio data (block 622).

FIG. 8 is a block diagram of an example programmable circuitry platform 800 structured to execute and/or instantiate the example machine-readable instructions and/or the example operations of FIGS. 6-7 to implement the multi-modality circuitry 108 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a gaming console, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example training data acquisition circuitry 202, the example encoder circuitry 204, the example diffusion circuitry 206, the example warp circuitry 208, the example 3D generation circuitry 110, the example image decoder circuitry 210, the example flow predictor circuitry 212, and the example multi-modality circuitry 108.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 6-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-7. As such, the FPGA circuitry 1000 may be configured and/or structured to effectively instantiate some or all of the operations/functions corresponding to the machine readable instructions of the flowchart(s) of FIGS. 6-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 6-7, and/or an ASIC may be configured and/or structured to perform third operation(s)/function(s) corresponding to a third portion of the machine readable instructions represented by the flowcharts of FIGS. 6-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

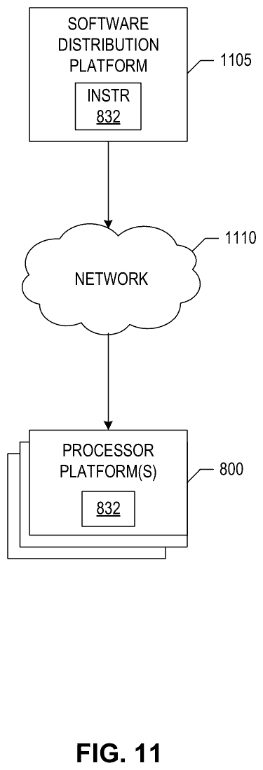

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 6-7, may be downloaded to the example programmable circuitry platform 800, which is to execute the machine readable instructions 832 to implement the multi-modality circuitry 108. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generate video output that is temporally aligned with audio based on prompt information to cause modification and/or movement of a source image. Examples disclosed herein reduce computational burdens when generating video output by, in part, translating video image frames from an optical space/format to latent space data. Flow information is learned from training operations that compare pairwise images to verify flow information from a reference image correctly represents flow translation(s) and/or rotation(s) to achieve an accurate driving image representation.

Example methods, apparatus, systems, and articles of manufacture to generate flow and audio multi-modal output are disclosed herein. Further examples and combinations thereof include the following: Example 1 includes an apparatus comprising interface circuitry, machine-readable instructions, and at least one processor circuit programmed by the machine-readable instructions to train an unsupervised image model to generate flow tensors based on a reference frame and a driver frame, the flow tensors including at least one of rotation information or translation information corresponding to differences relative to the reference frame and the driver frame, and train a denoising diffusion probabilistic model (DDPM) based on (a) the flow tensors, (b) audio distributions and (c) prompt signals, the trained DDPM to temporally align the flow tensors with the audio distributions.

Example 2 includes the apparatus as defined in example 1, wherein one or more of the at least one processor circuit is to transform representations of the reference frame and the driver frame from image space representations to latent space representations.

Example 3 includes the apparatus as defined in example 1 or example 2, wherein one or more of the at least one processor circuit is to warp at least one of the flow tensors based on a difference between a first representation of the reference frame and the driver frame.

Example 4 includes the apparatus as defined in one or more of example 1-3, wherein one or more of the at least one processor circuit is to inject noise into at least one of the flow tensors and into at least one of the audio distributions with a forward diffusion process, the forward diffusion process to generate noise infused flow tensors and noise infused audio distributions.

Example 5 includes the apparatus as defined in example 4, wherein one or more of the at least one processor circuit is to train the DDPM by reconstructing information from the noise infused flow tensors and the noise infused audio distributions.

Example 6 includes the apparatus as defined in example 5, wherein the DDPM executes a reverse diffusion process with a fully convolutional neural network.

Example 7 includes the apparatus as defined in one or more of example 1-6, wherein one or more of the at least one processor circuit is to warp at least one of the flow tensors based on the prompt signals and an input frame, and decode the warped flow tensors from a latent space representation to an image space representation.

Example 8 includes At least one non-transitory machine-readable medium comprising machine-readable instructions to cause at least one processor circuit to at least train an unsupervised image model to generate flow tensors based on a reference frame and a driver frame, the flow tensors including at least one of rotation information or translation information corresponding to differences relative to the reference frame and the driver frame, and train a denoising diffusion probabilistic model (DDPM) based on (a) the flow tensors, (b) audio distributions and (c) prompt signals, the trained DDPM to temporally align the flow tensors with the audio distributions.

Example 9 includes the at least one non-transitory machine-readable medium of example 8, wherein the machine-readable instructions are to cause one or more of the at least one processor circuit to transform representations of the reference frame and the driver frame from image space representations to latent space representations.

Example 10 includes the at least one non-transitory machine-readable medium of example 8 or example 9, wherein the machine-readable instructions are to cause one or more of the at least one processor circuit to warp at least one of the flow tensors based on a difference between a first representation of the reference frame and the driver frame.

Example 11 includes the at least one non-transitory machine-readable medium of one or more of example 8-10, wherein the machine-readable instructions are to cause one or more of the at least one processor circuit to inject noise into at least one of the flow tensors and into at least one of the audio distributions with a forward diffusion process.

Example 12 includes the at least one non-transitory machine-readable medium of one or more of example 8-11, wherein the machine-readable instructions are to cause one or more of the at least one processor circuit to generate noise infused flow tensors and noise infused audio distributions with a forward diffusion process.

Example 13 includes the at least one non-transitory machine-readable medium of example 12, wherein the machine-readable instructions are to cause one or more of the at least one processor circuit to train the DDPM by reconstructing information from the noise infused flow tensors and the noise infused audio distributions.

Example 14 includes the at least one non-transitory machine-readable medium of example 13, wherein the machine-readable instructions are to cause one or more of the at least one processor circuit to execute a reverse diffusion process with a fully convolutional neural network.

Example 15 includes the at least one non-transitory machine-readable medium of one or more of example 8-14, wherein the machine-readable instructions are to cause one or more of the at least one processor circuit to warp at least one of the flow tensors based on the prompt signals and an input frame, and decode the warped flow tensors from a latent space representation to an image space representation.

Example 16 includes a method comprising training, by at least one processor circuit programmed by at least one instruction, an unsupervised image model to generate flow tensors based on a reference frame and a driver frame, the flow tensors including at least one of rotation information or translation information corresponding to differences relative to the reference frame and the driver frame, and training, by one or more of the at least one processor circuit, a denoising diffusion probabilistic model (DDPM) based on (a) the flow tensors, (b) audio distributions and (c) prompt signals, the trained

DDPM to temporally align the flow tensors with the audio distributions.

Example 17 includes the method as defined in example 16, further including transforming representations of the reference frame and the driver frame from image space representations to latent space representations.

Example 18 includes the method as defined in example 16 or example 17, further including warping at least one of the flow tensors based on a difference between a first representation of the reference frame and the driver frame.

Example 19 includes the method as defined in one or more of example 16-18, further including injecting noise into at least one of the flow tensors and into at least one of the audio distributions with a forward diffusion process.

Example 20 includes the method as defined in one or more of example 16-19, further including generating noise infused flow tensors and noise infused audio distributions with a forward diffusion process.

Example 21 includes the method as defined in example 20, further including training the DDPM by reconstructing information from the noise infused flow tensors and the noise infused audio distributions.

Example 22 includes the method as defined in example 21, further including executing a reverse diffusion process with a fully convolutional neural network.

Example 23 includes the method as defined in one or more of example 16-22, further including warping at least one of the flow tensors based on the prompt signals and an input frame, and decoding the warped flow tensors from a latent space representation to an image space representation.

Example 24 includes an apparatus comprising means for encoding to train an unsupervised image model to generate flow tensors based on a reference frame and a driver frame, the flow tensors including at least one of rotation information or translation information corresponding to differences relative to the reference frame and the driver frame, and means for diffusing to train a denoising diffusion probabilistic model (DDPM) based on (a) the flow tensors, (b) audio distributions and (c) prompt signals, the trained DDPM to temporally align the flow tensors with the audio distributions.

Example 25 includes the apparatus as defined in example 24, wherein the means for encoding is to transform representations of the reference frame and the driver frame from image space representations to latent space representations.

Example 26 includes the apparatus as defined in example 24 or example 25, further including means for warping to warp at least one of the flow tensors based on a difference between a first representation of the reference frame and the driver frame.

Example 27 includes the apparatus as defined in one or more of example 24-26, wherein the means for diffusing is to inject noise into at least one of the flow tensors and into at least one of the audio distributions with a forward diffusion process, the forward diffusion process to generate noise infused flow tensors and noise infused audio distributions.

Example 28 includes the apparatus as defined in example 27, wherein the means for diffusing is to train the DDPM by reconstructing information from the noise infused flow tensors and the noise infused audio distributions.

Example 29 includes the apparatus as defined in example 28, wherein the DDPM executes a reverse diffusion process with a fully convolutional neural network.

Example 30 includes the apparatus as defined in one or more of example 24-29, further including means for warping to warp at least one of the flow tensors based on the prompt signals and an input frame, and means for three-dimensional generation to decode the warped flow tensors from a latent space representation to an image space representation.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit programmed by the machine-readable instructions to:
train an unsupervised image model to generate flow tensors based on a reference frame and a driver frame, the flow tensors representing at least one of rotation information or translation information; and
train a denoising diffusion probabilistic model (DDPM) based on (a) the flow tensors, (b) audio distributions and (c) prompt signals, the trained DDPM to temporally align the flow tensors with the audio distributions.

2. The apparatus as defined in claim 1, wherein one or more of the at least one processor circuit is to transform representations of the reference frame and the driver frame from image space representations to latent space representations.

3. The apparatus as defined in claim 1, wherein one or more of the at least one processor circuit is to warp at least one of the flow tensors based on a difference between a first representation of the reference frame and the driver frame.

4. The apparatus as defined in claim 1, wherein one or more of the at least one processor circuit is to inject noise into at least one of the flow tensors and into at least one of the audio distributions with a forward diffusion process, the forward diffusion process to generate noise infused flow tensors and noise infused audio distributions.

5. The apparatus as defined in claim 4, wherein one or more of the at least one processor circuit is to train the DDPM by reconstructing information from the noise infused flow tensors and the noise infused audio distributions.

6. The apparatus as defined in claim 5, wherein the DDPM executes a reverse diffusion process with a fully convolutional neural network.

7. The apparatus as defined in claim 1, wherein one or more of the at least one processor circuit is to:
warp at least one of the flow tensors based on the prompt signals and an input frame; and
decode the warped flow tensors from a latent space representation to an image space representation.

8. The apparatus as defined in claim 1, wherein the rotation information and translation information correspond to differences relative to the reference frame and the driver frame.

9. The apparatus as defined in claim 1, wherein the prompt signals include at least one of text input or vocal input, the prompt signals including instructions to cause modifications to an input frame.

10. At least one non-transitory machine-readable medium comprising machine-readable instructions to cause at least one processor circuit to at least:
train an unsupervised image model to generate flow tensors based on a reference frame and a driver frame, the flow tensors representing at least one of rotation information or translation information; and
train a denoising diffusion probabilistic model (DDPM) based on (a) the flow tensors, (b) audio distributions and (c) prompt signals, the trained DDPM to temporally align the flow tensors with the audio distributions.

11. The at least one non-transitory machine-readable medium of claim 10, wherein the machine-readable instructions are to cause one or more of the at least one processor circuit to transform representations of the reference frame and the driver frame from image space representations to latent space representations.

12. The at least one non-transitory machine-readable medium of claim 10, wherein the machine-readable instructions are to cause one or more of the at least one processor circuit to warp at least one of the flow tensors based on a difference between a first representation of the reference frame and the driver frame.

13. The at least one non-transitory machine-readable medium of claim 10, wherein the machine-readable instructions are to cause one or more of the at least one processor circuit to inject noise into at least one of the flow tensors and into at least one of the audio distributions with a forward diffusion process.

14. The at least one non-transitory machine-readable medium of claim 10, wherein the machine-readable instructions are to cause one or more of the at least one processor circuit to generate noise infused flow tensors and noise infused audio distributions with a forward diffusion process.

15. The at least one non-transitory machine-readable medium of claim 14, wherein the machine-readable instructions are to cause one or more of the at least one processor circuit to train the DDPM by reconstructing information from the noise infused flow tensors and the noise infused audio distributions.

16. The at least one non-transitory machine-readable medium of claim 15, wherein the machine-readable instructions are to cause one or more of the at least one processor circuit to execute a reverse diffusion process with a fully convolutional neural network.

17. The at least one non-transitory machine-readable medium of claim 10, wherein the machine-readable instructions are to cause one or more of the at least one processor circuit to:
warp at least one of the flow tensors based on the prompt signals and an input frame; and
decode the warped flow tensors from a latent space representation to an image space representation.

18. The at least one non-transitory machine-readable medium of claim 10, wherein the machine-readable instructions are to cause one or more of the at least one processor circuit to generate the at least one of rotation information or translation information corresponding to differences relative to the reference frame and the driver frame.

19. The at least one non-transitory machine-readable medium of claim 10, wherein the machine-readable instructions are to cause one or more of the at least one processor circuit to train the DDPM with the prompt signals having at least one of text input or vocal input, the prompt signals including instructions to cause modifications to an input frame.

20. A method comprising:
training, by at least one processor circuit programmed by at least one instruction, an unsupervised image model to generate flow tensors based on a reference frame and a driver frame, the flow tensors including at least one of rotation information or translation information corresponding to differences relative to the reference frame and the driver frame; and
training, by one or more of the at least one processor circuit, a denoising diffusion probabilistic model (DDPM) based on (a) the flow tensors, (b) audio distributions and (c) prompt signals, the trained DDPM to temporally align the flow tensors with the audio distributions.
